(19) United States
(12) Patent Application Publication
(10) Pub. No.: US 2026/0332912 A1
(43) Pub. Date: Oct. 22, 2026

(54) PHOTOELECTRIC CONVERSION DEVICE, PHOTOELECTRIC CONVERSION SYSTEM, MOVABLE OBJECT, AND EQUIPMENT

(71) Applicant: CANON KABUSHIKI KAISHA, Tokyo (JP)

(72) Inventor: JUMPEI ASHIDA, Cupertino, CA (US)

(21) Appl. No.: 19/707,116

(22) Filed: Jun. 12, 2026

Related U.S. Application Data
(63) Continuation of application No. PCT/JP2024/036961, filed on Oct. 17, 2024.

(30) Foreign Application Priority Data
Dec. 14, 2023 (JP) 2023-211216

(51) Int. Cl. H04N 25/773

(52) U.S. Cl. CPC H04N 25/773

(57) ABSTRACT

A photoelectric conversion device includes a plurality of photoelectric conversion units each configured to output a photon detection signal according to incidence of a photon, a plurality of counters each configured to count the photon detection signal of a corresponding photoelectric conversion unit, and a calculation unit configured to perform arithmetic processing based on count values of the plurality of counters, wherein the calculation unit includes a holding unit configured to hold count values of the plurality of counters, and a vector calculation unit configured to calculate a vector value representing an optical flow between a first time and a second time earlier than the first time based on a count value of the counter at the first time and a count value of the counter at the second time, count value being held by the holding unit.

### CROSS-REFERENCE TO RELATED APPLICATIONS

This application is a Continuation of International Patent Application No. PCT/JP 2024/036961, filed Oct. 17, 2024, which claims the benefit of Japanese Patent Application No. 2023-211216, filed Dec. 14, 2023, both of which are hereby incorporated by reference herein in their entirety.

### BACKGROUND

### Field of the Technology

The present disclosure relates to a photoelectric conversion device, a photoelectric conversion system, a movable object, and an equipment.

### Description of the Related Art

In recent years, automobiles, drones, and the like are provided with multiple image sensors in order to acquire an optical flow (also called a “motion vector”) as one of the purposes thereof. The optical flow is used, for example, for simultaneous localization and mapping (SLAM). In general, in order to acquire an optical flow, arithmetic processing using a Lucas-Kanade method, a block matching method, or the like is performed on moving image data (an image sequence captured every predetermined period). Japanese Patent Laid-Open No. 2021-520699 discloses an optical flow sensor configured to collect optical flow algorithm parameters.

There is a need to acquire an optical flow at a higher speed and with a lower latency than in the related art. However, in the configuration described in Japanese Patent Laid-Open No. 2021-520699, extraction of algorithm parameters necessary for calculation of an optical flow is realized in the sensor, but data processing outside the sensor is also necessary, and it is not possible to acquire an optical flow in the sensor at high speed.

### SUMMARY

The present disclosure is directed to provide a photoelectric conversion device capable of acquiring an optical flow at high speed without requiring data processing by an external device.

According to one disclosure of the present specification, there is provided a photoelectric conversion device including a plurality of photoelectric conversion units each configured to output a photon detection signal according to incidence of a photon, a plurality of counters each configured to count the photon detection signal of a corresponding photoelectric conversion unit, and a calculation unit configured to perform arithmetic processing based on count values of the plurality of counters, wherein the calculation unit includes a holding unit configured to hold count values of the plurality of counters, and a vector calculation unit configured to calculate a vector value representing an optical flow between a first time and a second time earlier than the first time based on a count value of the counter at the first time and a count value of the counter at the second time, count value being held by the holding unit.

According to another disclosure of the present specification, there is provided a photoelectric conversion device including a plurality of photoelectric conversion units each configured to output a photon detection signal according to incidence of a photon, a plurality of counters each configured to count the photon detection signal of a corresponding photoelectric conversion unit, and a calculation unit configured to perform arithmetic processing based on count values of the plurality of counters, wherein the calculation unit is configured to periodically acquire the count values from the plurality of counters while the counters perform a series of count operations, output a vector value representing an optical flow based on the acquired count values at a first cycle, and output the count values of the plurality of counters at a second cycle longer than the first cycle.

According to still another disclosure of the present specification, there is provided a photoelectric conversion device including a plurality of pixels each including a photoelectric conversion unit configured to output a photon detection signal according to incidence of a photon and a counter configured to count the photon detection signal of the photoelectric conversion unit, and a calculation unit configured to calculate a vector value representing an optical flow between a first time and a second time different from the first time based on count values of the counters of the plurality of pixels at the first time and count values of the counters of the plurality of pixels at the second time, wherein the plurality of pixels is divided into a plurality of pixel blocks each including two or more pixels and arranged to form a plurality of rows and a plurality of columns, wherein the calculation unit is provided for each of the plurality of pixel blocks, and wherein adjacent calculation units arranged in a same pixel block row or a same pixel block column are connected to each other, and the vector value output from one calculation unit is transferred through another calculation unit arranged in the same pixel block row or the same pixel block column.

Features of the present disclosure will become apparent from the following description of embodiments with reference to the attached drawings.

### BRIEF DESCRIPTION OF THE DRAWINGS

FIG. 1 is a block diagram illustrating a schematic configuration of a photoelectric conversion device according to a first embodiment.

FIG. 2 is an exploded perspective view illustrating a configuration example of the photoelectric conversion device according to the first embodiment.

FIG. 3 is a circuit diagram illustrating a configuration example of a pixel of the photoelectric conversion device according to the first embodiment.

FIG. 4 is a block diagram illustrating a configuration example of a calculation unit of the photoelectric conversion device according to the first embodiment.

FIG. 5 is a diagram illustrating a configuration example of a sub-pixel block in the photoelectric conversion device according to the first embodiment.

FIG. 6 is a timing chart illustrating a method of driving the photoelectric conversion device according to the first embodiment.

FIG. 7 is a block diagram illustrating a configuration example of a calculation unit of a photoelectric conversion device according to a second embodiment.

FIG. 8 is a block diagram illustrating a configuration example of a calculation unit of a photoelectric conversion device according to a third embodiment.

FIG. 9 is a block diagram illustrating a schematic configuration of an imaging system according to a fourth embodiment.

FIG. 10A is a diagram illustrating a configuration example of an imaging system according to a fifth embodiment.

FIG. 10B is a diagram illustrating a configuration example of a movable object according to the fifth embodiment.

FIG. 11 is a block diagram illustrating a schematic configuration of an equipment according to a sixth embodiment.

### DESCRIPTION OF THE EMBODIMENTS

### First Embodiment

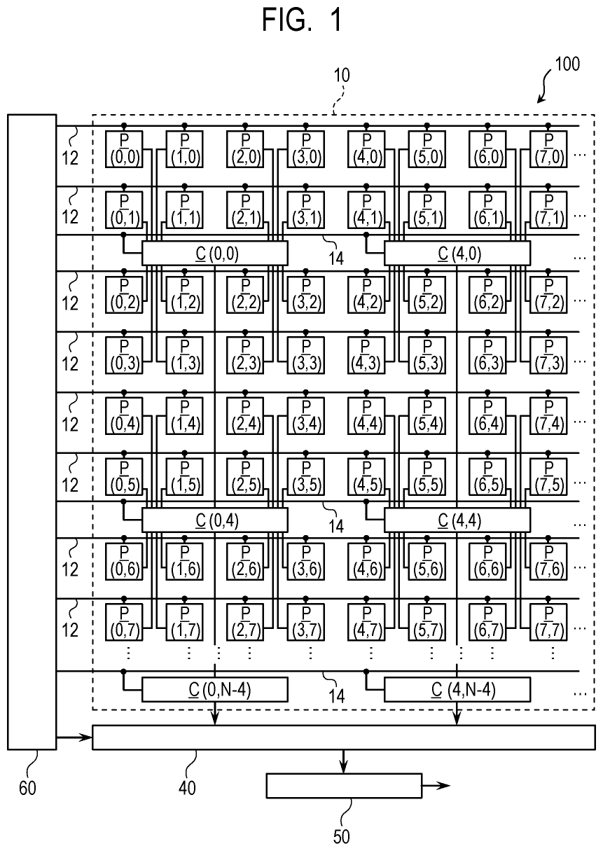

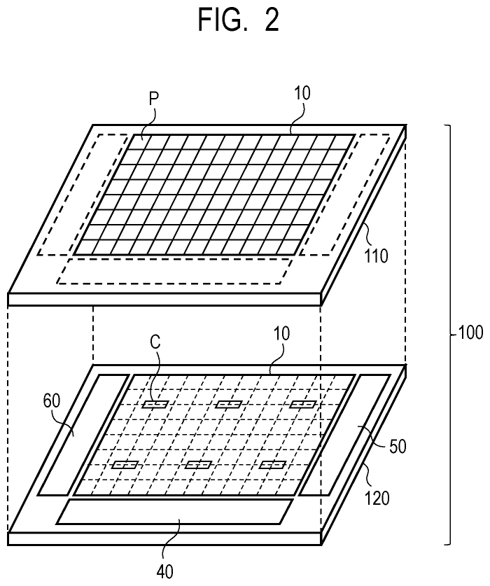

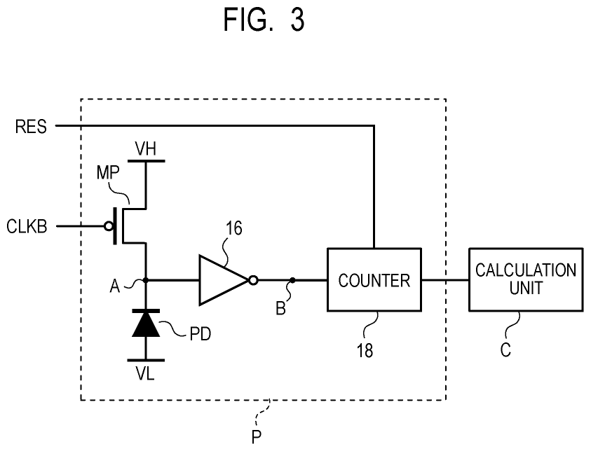

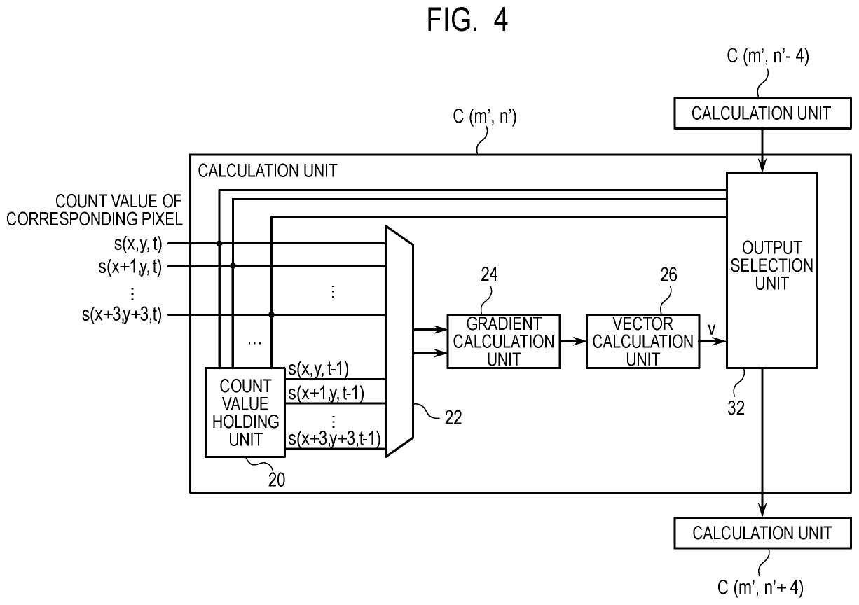

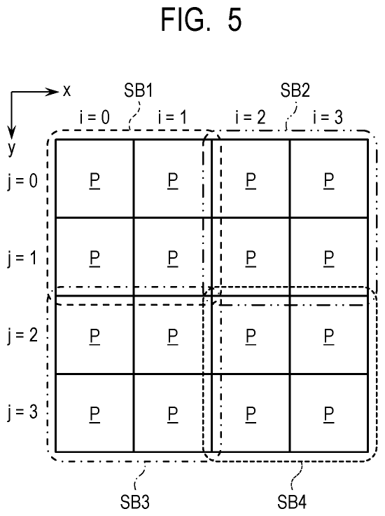

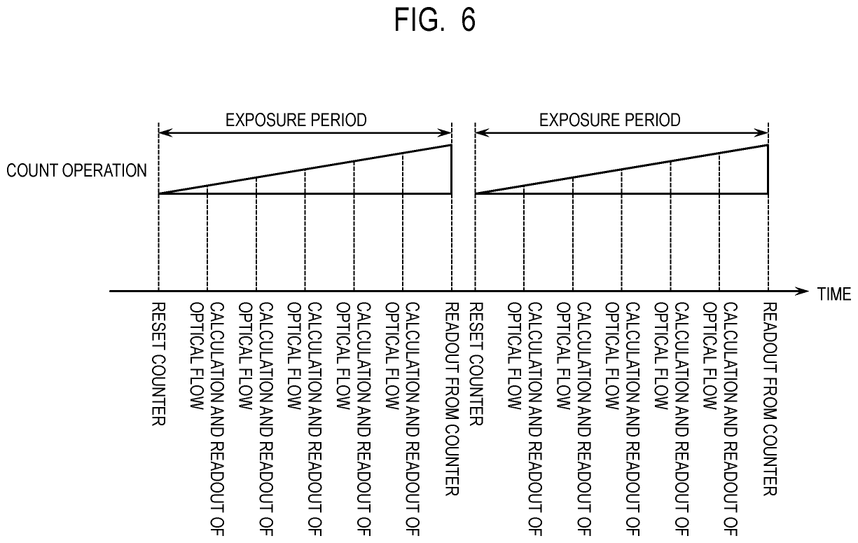

A photoelectric conversion device and a method of driving the same according to a first embodiment will be described with reference to FIG. 1 to FIG. 6. FIG. 1 is a block diagram illustrating a schematic configuration of a photoelectric conversion device according to the present embodiment. FIG. 2 is an exploded perspective view illustrating a configuration example of the photoelectric conversion device according to the present embodiment. FIG. 3 is a circuit diagram illustrating a configuration example of a pixel of the photoelectric conversion device according to the present embodiment. FIG. 4 is a block diagram illustrating a configuration example of a calculation unit of the photoelectric conversion device according to the present embodiment. FIG. 5 is a diagram illustrating a configuration example of a sub-pixel block in the photoelectric conversion device according to the present embodiment. FIG. 6 is a timing chart illustrating a method of driving the photoelectric conversion device according to the present embodiment.

As illustrated in FIG. 1, the photoelectric conversion device 100 according to the present embodiment includes a pixel/calculation unit 10, a signal processing unit 40, an output interface unit (output IF unit) 50, and a control unit 60. The pixel/calculation unit 10 is provided with a plurality of pixels P arranged to form a plurality of rows and a plurality of columns, and a plurality of calculation units C provided for each pixel block including a predetermined number of pixels P.

The pixel/calculation unit 10 may be provided with a plurality of pixels P arranged in a two-dimensional array of, for example, (M-number of columns)×(N-number of rows). In FIG. 1, coordinates (m, n) representing a column number m and a row number n are added to a reference symbol P of each pixel. Here, M and N are integers of 1 or more, m is an integer of 0 or more and less than M, and n is an integer of 0 or more and less than N.

The calculation unit C is a functional block that performs arithmetic processing based on an output signal from the pixel P. One calculation unit C may be provided for each pixel block including a predetermined number of pixels P. Here, each pixel block may include two or more pixels P arranged in (I-number of columns)×(J-number of rows). One of I and J may be an integer of 2 or more, and the other may be an integer of 1 or more. For example, in the example of FIG. 1, one calculation unit C is provided for each pixel block of (4 columns)×(4 rows). In FIG. 1, coordinates (m′, n′) for distinguishing these are added to a reference character C of the calculation unit. When the calculation unit C is provided for each pixel block of (I-number of column)×(J-number of rows), m′ is a multiple of I and n′ is a multiple of J. For example, the calculation unit C corresponding to a pixel block of (4 columns)×(4 rows) including the pixel P(0, 0) and the pixel P(3, 3) in the corner portion in the diagonal direction is the calculation unit C(0, 0). The calculation unit C corresponding to the pixel block of (4 columns)×(4 rows) including the pixel P(4, 4) and the pixel P(7, 7) in the corner portion in the diagonal direction is the calculation unit C(4, 4). A predetermined number (for example, 16) of pixels P included in one pixel block are connected to a calculation unit C provided corresponding to the one pixel block. In this specification, a bundle of rows corresponding to the pixel block may be referred to as a pixel block row, and a bundle of columns corresponding to the pixel block may be referred to as a pixel block column.

Each row of the pixel/calculation unit 10 is provided with a control line 12 extending in a first direction (lateral direction in FIG. 1). Each of the control lines 12 is connected to each of the pixels P arranged in the corresponding row, and forms a signal line common to these pixels P. A plurality of control lines 14 are arranged in the pixel/calculation unit 10 so as to extend in the first direction. Each of the control lines 14 is connected to each of the calculation units C having a common row coordinate (n′), and forms a common signal line to these calculation units C. For example, one control line 14 is connected to the calculation unit C(0, 0) and the calculation unit C(4, 0), and another control line 14 is connected to the calculation unit C(0, 4) and the calculation unit C(4, 4). The first direction in which the control lines 12 and 14 extend may be referred to as a row direction or a horizontal direction. Each of the control lines 12 and 14 may include a plurality of signal lines for supplying a plurality of types of control signals to the pixel P or the calculation unit C. The control lines 12 and 14 of each row are connected to the control unit 60.

The calculation unit C(m′, n′) is connected to a calculation unit C(m′, n′−J) and a calculation unit C(m′, n′+J) adjacent to each other in a second direction (vertical direction in FIG. 1) intersecting the first direction. The calculation unit C(m′, N−J) arranged at the end in the second direction is connected to the signal processing unit 40. Thus, the calculation results of the calculation units C(m′, 0) to C(m′, N−J) may be transferred to the signal processing unit 40 in the column direction. The second direction in which the data of the calculation unit C is transferred may be referred to as a column direction or a vertical direction.

The signal processing unit 40 performs predetermined signal processing on the data received from the calculation unit C, and outputs the processed data to the output IF unit 50. The output IF unit 50 is a circuit for transmitting data after signal processing by the signal processing unit 40 to a system outside the photoelectric conversion device 100 and includes, for example, a serializer for converting parallel data into serial data and an external interface circuit.

The control unit 60 is a control circuit having a function of generating control signals for controlling operations and timings thereof of the pixel/calculation unit 10, the signal processing unit 40, and the output IF unit 50, and supplying the generated control signal to each functional block.

The photoelectric conversion device 100 according to the present embodiment may have a configuration in which the functional blocks described above are arranged on one substrate or may have a configuration as a stacked-type photoelectric conversion device in which the functional blocks described above are separately formed on a plurality of substrates and these substrates are bonded and electrically connected. The stacked-type photoelectric conversion device may have a structure in which two substrates are bonded to each other or a structure in which three or more substrates are bonded to each other. In order to electrically connect the plurality of substrates, a technique called through silicon via (TSV) in which a metal member is buried in a through-hole penetrating one substrate and an insulating layer among the plurality of substrates and an interconnection layer of another substrate is connected to the metal member, may be used. As another mode of electrical connection of the plurality of substrates, hybrid bonding in which bonding of the plurality of insulating layers and bonding of the plurality of metal portions are formed on a bonding surface where the insulating layers of the plurality of substrates are bonded to each other may be used. The material of the metal portion to be bonded is typically copper. The plurality of metal portions to be bonded are connected to interconnection layers of the respective substrates. Thus, the plurality of substrates may be electrically connected to each other. These electrical connection methods are merely examples, and various methods of electrically connecting a plurality of substrates, such as bonding using micro bumps and the like, may be employed.

FIG. 2 is a schematic diagram illustrating a case where the photoelectric conversion device 100 is configured by stacking the pixel substrate 110 and the circuit substrate 120. On the pixel substrate 110, for example, the pixels P among the constituent elements of the pixel/calculation unit 10 may be arranged. On the circuit substrate 120, for example, the calculation units C among the constituent elements of the pixel/calculation unit 10, the signal processing unit 40, the output IF unit 50, and the control unit 60 may be arranged. In this case, for example, as illustrated in FIG. 2, the pixels P and the calculation units C may be arranged in an overlapping region in a plan view. By arranging the pixels P and the other constituent elements on different substrates, it is possible to reduce the size and increase the functionality of the photoelectric conversion device 100 without sacrificing the light receiving area of each pixel P.

Next, a configuration example of the pixel P will be described with reference to FIG. 3. Each of the pixels P may include, as illustrated in, e.g., FIG. 3, a photoelectric conversion element PD, a switch unit MP, a waveform shaping unit 16, and a counter 18. The photoelectric conversion element PD may be formed of an avalanche photodiode (hereinafter referred to as “APD”). The switch unit MP may be formed of a p-channel MOS transistor. The photoelectric conversion element PD, the switch unit MP, and the waveform shaping unit 16 constitute a photoelectric conversion unit that outputs a photon detection signal according to incidence of a photon.

An anode of the APD constituting the photoelectric conversion element PD is connected to a node to which a voltage VL is supplied. A cathode of the APD constituting the photoelectric conversion element PD is connected to a drain of the p-channel MOS transistor constituting the switch unit MP. A source of the p-channel MOS transistor constituting the switch unit MP is connected to a node to which a voltage VH is supplied. An input node of the waveform shaping unit 16 is connected to a connection node (node-A) between the photoelectric conversion element PD and the switch unit MP. An output node of the waveform shaping unit 16 is connected to an input node of the counter 18. An output node of the counter 18 is connected to the calculation unit C corresponding to the pixel P. A signal CLKB, which is an inverted signal of the clock signal CLK, is input from the control unit 60 to a gate of the p-channel MOS transistor constituting the switch unit MP via the control line 12. A reset signal RES for resetting the count value is input to a control node of the counter 18 from the control unit 60 via the control line 12.

The photoelectric conversion element PD may be configured by an APD as described above. The voltage VL and the voltage VH are set so that a reverse bias voltage sufficient for the APD to perform the avalanche multiplication operation is applied. In one example, a negative high voltage is applied as the voltage VL, and a positive voltage comparable to the power supply voltage is applied as the voltage VH. For example, the voltage VL is about −30 V, and the voltage VH is about 1 V. When a reverse bias voltage sufficient to perform the avalanche multiplication operation is supplied to the APD, carriers generated by light incident on the APD cause avalanche multiplication, and an avalanche current is generated. The operation modes in a state where the reverse bias voltage is supplied to the APD include a Geiger mode and a linear mode. The Geiger mode is an operation mode in which a voltage applied between the anode and the cathode is set to a reverse bias voltage larger than a breakdown voltage of the APD. The linear mode is an operation mode in which a voltage applied between an anode and a cathode is set to a reverse bias voltage close to or lower than the breakdown voltage of the APD. An APD that operates in Geiger mode is referred to as a single photon avalanche diode (SPAD). The APD constituting the photoelectric conversion element PD is operated in the Geiger mode in the present embodiment. However, the present disclosure is not limited to this mode, and the APD may be operated in the linear mode.

The switch unit MP has a function of switching between a period (photon detection period) in which a photon incident on the photoelectric conversion element PD is detected and a period (charging period) in which the photoelectric conversion element PD is charged. That is, when the switch unit MP is turned on by receiving the low-level signal CLKB from the control unit 60, the voltage VH is supplied to the node-A, and the photoelectric conversion element PD is charged. When the switch unit MP is turned off in response to the high-level signal CLKB from the control unit 60, the node-A is disconnected from the voltage VH, and the potential of the node-A may be changed in accordance with the incidence of the photon.

The waveform shaping unit 16 has a function of shaping a voltage waveform of the node-A and converting the voltage waveform into a photon detection pulse signal indicating that a photon has entered the photoelectric conversion element PD during the photon detection period. That is, the waveform shaping unit 16 outputs a high-level signal (photon detection signal) in a case where the potential of the node-A becomes lower than a predetermined determination threshold value in response to incidence of a photon on the photoelectric conversion element PD during a period in which the signal CLKB is at high-level (photon detection period). The signal level of the output node (node-B) of the waveform shaping unit 16 becomes low-level at the timing when the photon detection period ends, that is, at the falling edge when the signal CLKB next transitions from high-level to low-level. The waveform shaping unit 16 may be constituted by a logic circuit such as an inverter circuit.

The counter 18 is, for example, a counter that counts up every time a rising edge of the photon detection signal output from the waveform shaping unit 16 is detected, performs a counting operation of the rising edge of the photon detection signal, and holds a count value that is a counting result. Thus, the counter 18 counts the number of avalanche multiplications occurring during a predetermined exposure period. The count value in the counter 18 is reset in accordance with the reset signal RES from the control unit 60.

The counter 18 is connected to the calculation unit C corresponding to the pixel block including the pixel P without passing through a selection circuit or the like. In other words, the calculation unit C may always read the count value held by the counter 18. That is, even when the counter 18 is continuously performing the count operation, the calculation unit C may read the count value at that time from the counter 18 at an arbitrary timing. After reading the count value, the counter 18 may continue the count operation from the count value at that time.

The pixel P may include at least a photoelectric conversion unit that outputs a photon detection signal according to incidence of a photon, and a counter that counts a photon detection signal output from the photoelectric conversion unit and is not limited to the configuration example described above. For example, the pixel P may have an active quenching type quenching circuit instead of the switch unit MP. Further, in the present specification, the pixel P is described as including one photoelectric conversion element PD and one counter 18, but is not limited to this example. That is, one pixel P may include a plurality of photoelectric conversion elements PD and one counter 18 (that is, one counter 18 is shared by a plurality of photoelectric conversion elements PD). One pixel P may include one photoelectric conversion element PD and a plurality of counters 18 (that is, the plurality of counters 18 share one photoelectric conversion element PD). Although the calculation unit C is described as a mode in which the count value of the counter 18 of each of the plurality of pixels P is input, the calculation unit C may have a configuration in which the count values of the plurality of counters 18 each of which counts the photon detection signals of the photoelectric conversion elements PD are input.

Next, a configuration example of the calculation unit C will be described with reference to FIG. 4. As illustrated in, e.g., FIG. 4, each of the calculation units C may be constituted by a count value holding unit 20, a selector 22, a gradient calculation unit 24, a vector calculation unit 26, and an output selection unit 32. The count value holding unit 20 is connected to the selector 22 and the output selection unit 32. The selector 22 is connected to the gradient calculation unit 24. The gradient calculation unit 24 is connected to the vector calculation unit 26. The vector calculation unit 26 is connected to the output selection unit 32. The output selection units 32 of the calculation units C adjacent to each other in the column direction are connected to each other. For example, the output selection unit 32 of the calculation unit C(m′, n′) is connected to the output selection unit 32 of the calculation unit C(m′, n′−4) and the output selection unit 32 of the calculation unit C(m′, n′+4).

The count value s(x+i, y+j, t) at a time t of the pixel P included in the corresponding pixel block to the calculation unit C(m′, n′) is input to the calculation unit C(m′, n′). Here, x and y represent column number and row number corresponding to m′ and n′, i is an integer of 0 or more and less than I, and j is an integer of 0 or more and less than J. For example, in a case where the calculation unit C(m′, n′) corresponds to a pixel block of (4 columns)×(4 rows), a total of 16 count values s(x+i, y+j, t) of s(x, y, t), s(x+1, y, t), . . . , and s(x+3, y+3, t) are input to the calculation unit C(m′, n′). The count value s(x+i, y+j, t) is input to the count value holding unit 20, the selector 22, and the output selection unit 32.

The count value holding unit 20 imports and holds the count value s(x+i, y+j, t) from the pixel P at a predetermined cycle. When the count value s(x+i, y+j, t) is imported into the count value holding unit 20 from the pixel P, the count value s(x+i, y+j, t−1) one cycle before is held in the count value holding unit 20. The count value holding unit 20 outputs the held count value s(x+i, y+j, t−1) one cycle before to the selector 22.

The selector 22 sequentially selects two count values s of the count value s(x+i, y+j, t) held by the pixel P and the count value s(x+i, y+j, t−1) one cycle before held by the count value holding unit 20 and outputs to the gradient calculation unit 24.

The gradient calculation unit 24 calculates gradients in the x direction (row direction), the y direction (column direction), and the t direction (time direction) for each sub-pixel block SB of (2 columns)×(2 rows). The gradient is a parameter representing a spatial/temporal luminance gradient. These gradients may be calculated by calculating a difference between the count values s selected by the selector 22 and further adding the calculated difference to another difference. For example, in a case where a pixel block corresponding to one calculation unit C is configured by pixels P of (4 columns)×(4 rows), each pixel block may include four sub-pixel blocks SB1, SB2, SB3, and SB4 arranged in (2 columns)×(2 rows) as illustrated in FIG. 5. In a case where the gradients in the x direction, the y direction, and the t direction of the sub-pixel block SBk are expressed as grad_xk, grad_yk, and grad_tk, respectively, they may be expressed as follows.

grad_x1=s(x, y, t)−s(x+1, y, t)+s(x, y+1, t)−s(x+1, y+1, t)

grad_x2=s(x+2, y, t)−s(x+3, y, t)+s(x+2, y+1, t)−s(x+3, y+1, t)

grad_x3=s(x, y+2, t)−s(x+1, y+2, t)+s(x, y+3, t)−s(x+1, y+3, t)

grad_x4=s(x+2, y+2, t)−s(x+3, y+2, t)+s(x+2, y+3, t)−s(x+3, y+3, t)

grad_y1=s(x, y, t)−s(x, y+1, t)+s(x+1, y, t)−s(x+1, y+1, t)

grad_y2=s(x+2, y, t)−s(x+2, y+1, t)+s(x+3, y, t)−s(x+3, y+1, t)

grad_y3=s(x, y+2, t)−s(x, y+3, t)+s(x+1, y+2, t)−s(x+1, y+3, t)

grad_y4=s(x+2, y+2, t)−s(x+2, y+3, t)+s(x+3, y+2, t)−s(x+3, y+3, t)

grad_t1=s(x, y, t)−s(x, y, t−1)+s(x+1, y, t)−s(x+1, y, t−1)+s(x, y+1, t)−s(x, y+1, t−1)+s(x+1, y+1, t)−s(x+1, y+1, t−1)

grad_t2=s(x+2, y, t)−s(x+2, y, t−1)+s(x+3, y, t)−s(x+3, y, t−1)+s(x+2, y+1, t)−s(x+2, y+1, t−1)+s(x+3, y+1, t)−s(x+3, y+1, t−1)

grad_t3=s(x, y+2, t)−s(x, y+2, t−1)+s(x+1, y+2, t)−s(x+1, y+2, t−1)+s(x, y+3, t)−s(x, y+3, t−1)+s(x+1, y+3, t)−s(x+1, y+3, t−1)

grad_t4=s(x+2, y+2, t)−s(x+2, y+2, t−1)+s(x+3, y+2, t)−s(x+3, y+2, t−1)+s(x+2, y+3, t)−s(x+2, y+3, t−1)+s(x+3, y+3, t)−s(x+3, y+3, t−1)

Here, it is assumed that the vector value v of the optical flow to be calculated is v=(vₓ, v_{y}). According to the Lucas-Kanade method, the following optical flow constraint equation is established for each sub-pixel block SB.

grad_x1×vₓ+grad_y1×v_{y}=−grad_t1 (1)

grad_x2×vₓ+grad_y2×v_{y}=−grad_t2 (2)

grad_x3×vₓ+grad_y3×v_{y}=−grad_t3 (3)

grad_x4×vₓ+grad_y4×v_{y}=−grad_t4 (4)

Here, the following matrix A and matrix b are defined.

$$A = [ \begin{matrix}grad\_x 1 & grad\_x2 & grad\_x3 & grad\_x4 \\ grad\_y 1 & grad\_y2 & grad\_y3 & grad\_y4\end{matrix} ]$$

$$b = [ \begin{matrix}‐ grad\_t1 \\ ‐ grad\_t2 \\ ‐ grad\_t3 \\ ‐ grad\_t4\end{matrix} ]$$

By rewriting Expressions (1) to (4) using the matrix A and the matrix b, the following Expression (5) may be expressed.

Av=b (5)

By solving the Expression (5) for the vector value v, the following Expression (6) is obtained.

v=(A^{T}A)⁻¹A^{T}b (6)

The vector calculation unit 26 calculates the vector value v of the optical flow from the gradient calculated by the gradient calculation unit 24 based on the matrix equation of Expression (6) and outputs the vector value v to the output selection unit 32.

In this way, the count value s(x+i, y+j, t) at the time t and the vector value v of the optical flow are input to the output selection unit 32. The output selection unit 32 of the calculation unit C(m′, n′) outputs at least one of the count value s(x+i, y+j, t) and the vector value v to the output selection unit 32 of the calculation unit C(m′, n′+4) adjacent to the downstream side in the column direction under the control of the control unit 60. In this manner, the data held by the output selection unit 32 of each calculation unit C is sequentially transferred to the calculation unit C on the downstream side (on the side of the signal processing unit 40), whereby the data of all of the calculation units C(m′, 0) to C(m′, N−4) may be output to the signal processing unit 40.

According to such a configuration, it is possible to read out both the vector value v of the optical flow and the count value s(x+i, y+j, t). It is also possible to selectively read out one of the vector value v of the optical flow and the count value s(x+i, y+j, t). Which of them is read out may be switched according to an instruction of the control unit 60 or the like in accordance with the operation mode.

Next, an operation example of the photoelectric conversion device according to the present embodiment will be described with reference to FIG. 6. FIG. 6 schematically illustrates temporal changes in the count value of the counter 18 and the operation of the calculation unit C in two consecutive exposure periods.

The counter 18 continuously executes a series of count operations during each exposure period. That is, the counter 18 does not reset the count value until the exposure period ends except for resetting the count value at the start of the exposure period. The count value holding unit 20 captures the count value of the counter 18 periodically a plurality of times during the exposure period. In the operation example of FIG. 6, the count value is captured seven times during one exposure period, including when the counter 18 is reset. Since the calculation unit C of the photoelectric conversion device according to the present embodiment may refer to the value of the counter 18 of the pixel P at any time, the calculation unit C may calculate the optical flow by referring to the count value in the middle of the exposure period.

In the operation example of FIG. 6, the optical flow is calculated and read out five times during one exposure period. After the exposure period elapses, the output selection unit 32 of the calculation unit C outputs the count value of the counter 18 at that time. In the case of this operation example, when the readout speed of the count value (that is, the normal image readout) is, for example, 60 fps, the optical flow may be read out at a speed corresponding to 300 fps.

Since the optical flow is based on the first-order Taylor approximation of the relational expression representing the movement of the object, the higher the time resolution, the smaller the error of the first-order approximation may be made. In the present embodiment, since one vector value v is obtained for a pixel block including the pixels P of (I columns)×(J rows), the spatial resolution is 1/16 of the readout data from the counter 18. Therefore, it is possible to calculate the optical flow at a high speed without significantly pressing the band of readout or the band of the output IF.

As described above, according to the present embodiment, it is possible to realize a photoelectric conversion device capable of acquiring an optical flow at high speed without requiring data processing by an external device.

### Second Embodiment

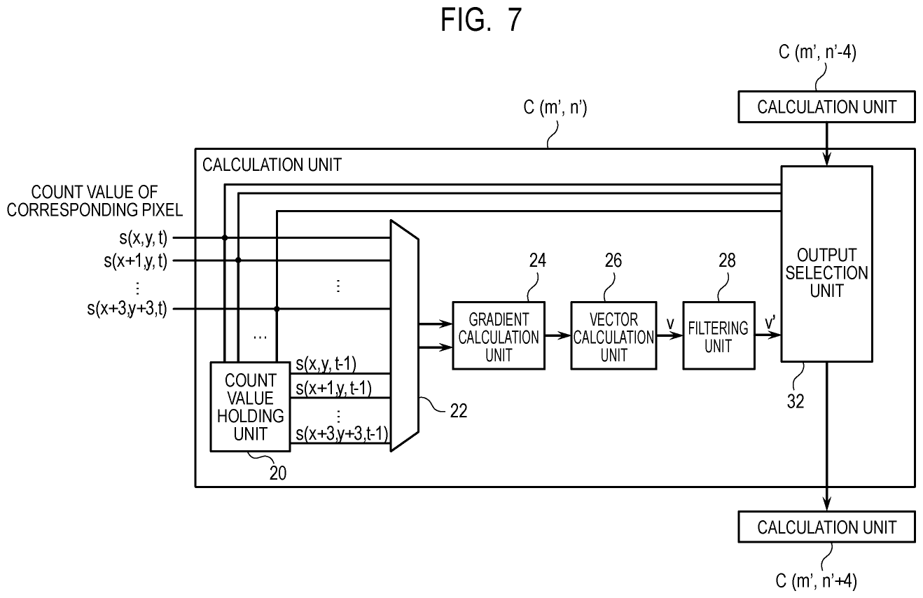

A photoelectric conversion device and a method of driving the same according to a second embodiment will be described with reference to FIG. 7. The same components as those of the photoelectric conversion device according to the first embodiment are denoted by the same reference numerals, and description thereof will be omitted or simplified. FIG. 7 is a block diagram illustrating a configuration example of a calculation unit in the photoelectric conversion device according to the present embodiment.

The photoelectric conversion device according to the present embodiment is the same as the photoelectric conversion device according to the first embodiment except that the configuration of the calculation unit C is different. In the present embodiment, differences from the photoelectric conversion device of the first embodiment will be mainly described, and description of portions similar to those of the photoelectric conversion device of the first embodiment will be appropriately omitted.

As illustrated in FIG. 7, the photoelectric conversion device according to the present embodiment is different from the photoelectric conversion device according to the first embodiment in that the calculation unit C further includes a filtering unit 28. The filtering unit 28 is connected between the vector calculation unit 26 and the output selection unit 32. The filtering unit 28 performs a filtering process using, for example, the similarity in the time direction on the vector value v output from the vector calculation unit 26, and outputs the processed vector value v′ to the output selection unit 32. As the filtering unit 28, a low-pass filter such as a moving average filter, a Kalman filter, or the like may be implemented.

In general, the count value s(x+i, y+j, t) output from the pixel P includes a noise component such as photon shot noise, and the vector value v calculated based on the count value s(x+i, y+j, t) also includes an error component. By performing the filtering process on the vector value v in the filtering unit 28 and removing the error component superimposed on the vector value v, it is possible to obtain the optical flow with higher accuracy.

As described above, according to the present embodiment, it is possible to realize a photoelectric conversion device capable of acquiring an optical flow at high speed without requiring data processing by an external device.

### Third Embodiment

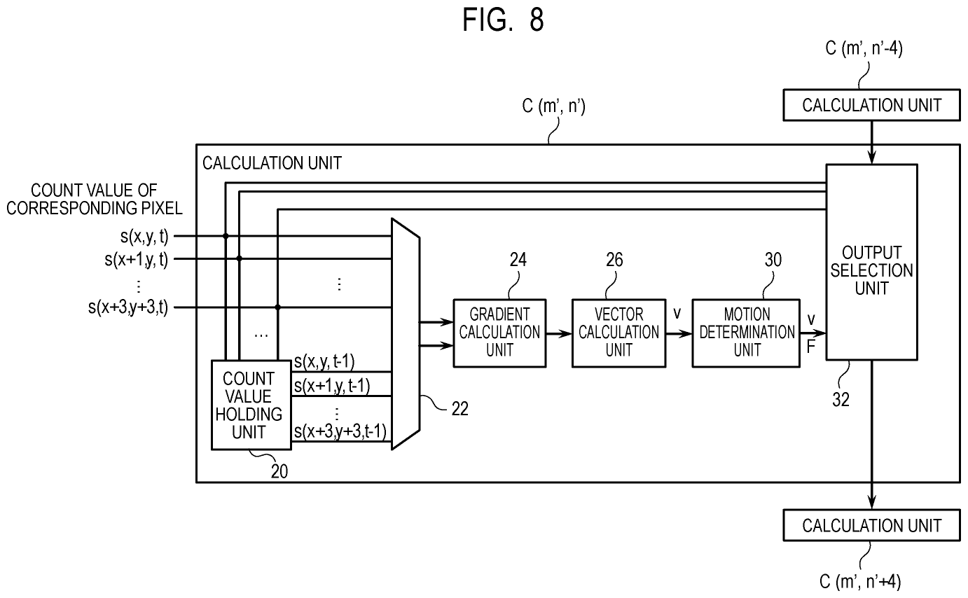

A photoelectric conversion device and a method of driving the same according to a third embodiment will be described with reference to FIG. 8. The same components as those of the photoelectric conversion device according to the first or second embodiment are denoted by the same reference numerals, and description thereof will be omitted or simplified. FIG. 8 is a block diagram illustrating a configuration example of a calculation unit in the photoelectric conversion device according to the present embodiment.

The photoelectric conversion device according to the present embodiment is the same as the photoelectric conversion device according to the first embodiment except that the configuration of the calculation unit C is different. In the present embodiment, differences from the photoelectric conversion device of the first embodiment will be mainly described, and description of portions similar to those of the photoelectric conversion device of the first embodiment will be appropriately omitted.

As illustrated in FIG. 8, the photoelectric conversion device according to the present embodiment is different from the photoelectric conversion device according to the first embodiment in that the calculation unit C further includes a motion determination unit 30. The motion determination unit 30 is connected between the vector calculation unit 26 and the output selection unit 32. The motion determination unit 30 has a function of determining whether the obtained optical flow is zero or close to zero based on the vector value v calculated by the vector calculation unit 26.

In the first embodiment, regardless of the magnitude of the calculated vector value v of the optical flow, all the calculation units C output the vector value v. However, there is a case in which a region in which an object moves is limited to only a partial region of an image depending on a photographing situation such as a case in which a camera is fixed. In such a case, it is possible to improve the frame rate and reduce the power consumption by outputting the vector value v only from the calculation unit C corresponding to the region in which the object is moving.

Therefore, in the present embodiment, the motion determination unit 30 determines whether or not the obtained optical flow is zero or close to zero, and when it is determined that there is no object motion, the vector value v is not output, and only the signal F indicating that there is no motion in the object is output. Specifically, if the absolute value of the vector value v is larger than a predetermined value, the motion determination unit 30 determines that the object has motion, and outputs the vector value v received from the vector calculation unit 26 to the output selection unit 32. On the other hand, if the absolute value of the vector value v is equal to or less than a predetermined value, the motion determination unit 30 determines that the object does not move, and outputs a signal F indicating that the object does not move to the output selection unit 32.

Note that the motion determination unit 30 is not limited to the configuration of determining the presence or absence of motion from the magnitude of the vector value v, and may be configured to determine the presence or absence of motion based on whether or not the value of the gradient (grad_t1 to grad_t4) in the t-direction is close to zero. In the case where the presence or absence of motion is determined based on the gradient in the t-direction, it is not necessary to perform calculation in the vector calculation unit 26 when there is no motion, and therefore, higher-speed processing and lower power consumption may be achieved.

As described above, according to the present embodiment, it is possible to realize a photoelectric conversion device capable of acquiring an optical flow at high speed without requiring data processing by an external device.

### Fourth Embodiment

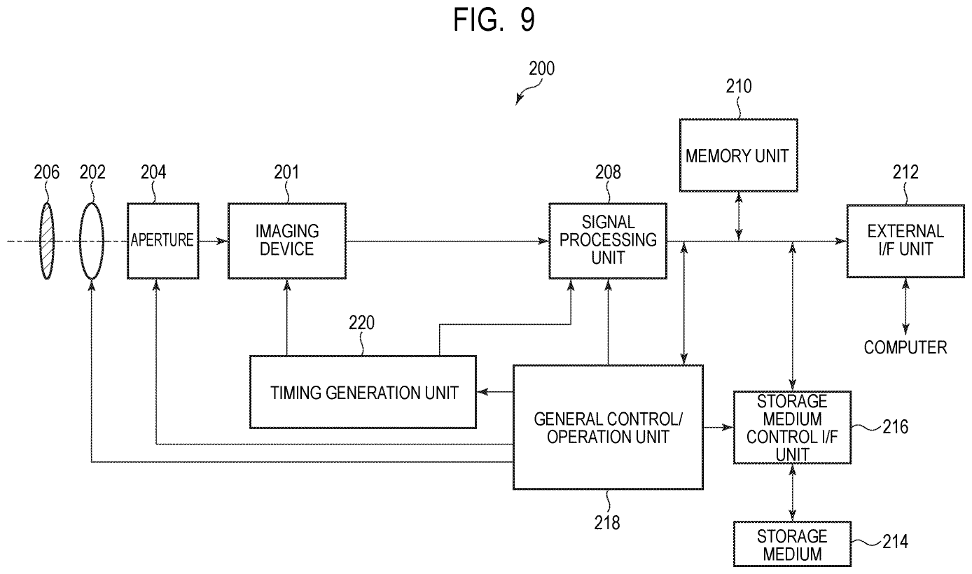

A photoelectric conversion system according to a fourth embodiment will be described with reference to FIG. 9. FIG. 9 is a block diagram illustrating a schematic configuration of a photoelectric conversion system according to the present embodiment.

The photoelectric conversion device 100 described in the first to third embodiments may be applied to various photoelectric conversion systems. Examples of applicable photoelectric conversion systems include digital still cameras, digital camcorders, surveillance cameras, copying machines, facsimiles, mobile phones, in-vehicle cameras, observation satellites, and the like. A camera module including an optical system such as a lens and an imaging device is also included in the photoelectric conversion system. FIG. 9 exemplifies a block diagram of a digital still camera as one of these.

The photoelectric conversion system 200 illustrated in FIG. 9 includes an imaging device 201, a lens 202 that forms an optical image of an object on the imaging device 201, an aperture 204 that changes the amount of light passing through the lens 202, and a barrier 206 that protects the lens 202. The lens 202 and the aperture 204 constitute an optical system that focuses light onto the imaging device 201. The imaging device 201 is the photoelectric conversion device 100 described in any of the first to third embodiments, and converts the optical image formed by the lens 202 into image data.

The photoelectric conversion system 200 further includes a signal processing unit 208 that processes an output signal output from the imaging device 201. The signal processing unit 208 generates image data from the digital signal output from the imaging device 201. Further, the signal processing unit 208 performs various corrections and compressions as necessary and outputs the processed image data. The imaging device 201 may include an analog-to-digital (AD) conversion unit that generates a digital signal to be processed by the signal processing unit 208. The AD conversion unit may be formed on a semiconductor layer (semiconductor substrate) on which the photoelectric conversion unit of the imaging device 201 is formed or may be formed on a semiconductor layer (semiconductor substrate) different from the semiconductor layer (semiconductor substrate) on which the photoelectric conversion unit of the imaging device 201 is formed. The signal processing unit 208 may be formed on the same semiconductor layer (semiconductor substrate) as the imaging device 201.

The photoelectric conversion system 200 further includes a memory unit 210 for temporarily storing image data and an external interface unit (external I/F unit) 212 for communicating with an external computer or the like. The photoelectric conversion system 200 further includes a storage medium 214 such as a semiconductor memory for performing storing or reading out of imaging data, and a storage medium control interface unit (storage medium control I/F unit) 216 for performing storing or reading out from the storage medium 214. The storage medium 214 may be built in the photoelectric conversion system 200 or may be detachable.

The photoelectric conversion system 200 further includes a general control/operation unit 218 that performs various calculations and controls the entire digital still camera, and a timing generation unit 220 that outputs various timing signals to the imaging device 201 and the signal processing unit 208. Here, the timing signal or the like may be input from the outside, and the photoelectric conversion system 200 may include at least the imaging device 201 and the signal processing unit 208 that processes the output signal output from the imaging device 201.

The imaging device 201 outputs an imaging signal to the signal processing unit 208. The signal processing unit 208 performs predetermined signal processing on the imaging signal output from the imaging device 201, and outputs the processed image data. The signal processing unit 208 generates an image using the imaging signal.

As described above, according to the present embodiment, it is possible to realize a photoelectric conversion system to which the photoelectric conversion device 100 according to any of the first to third embodiments is applied.

### Fifth Embodiment

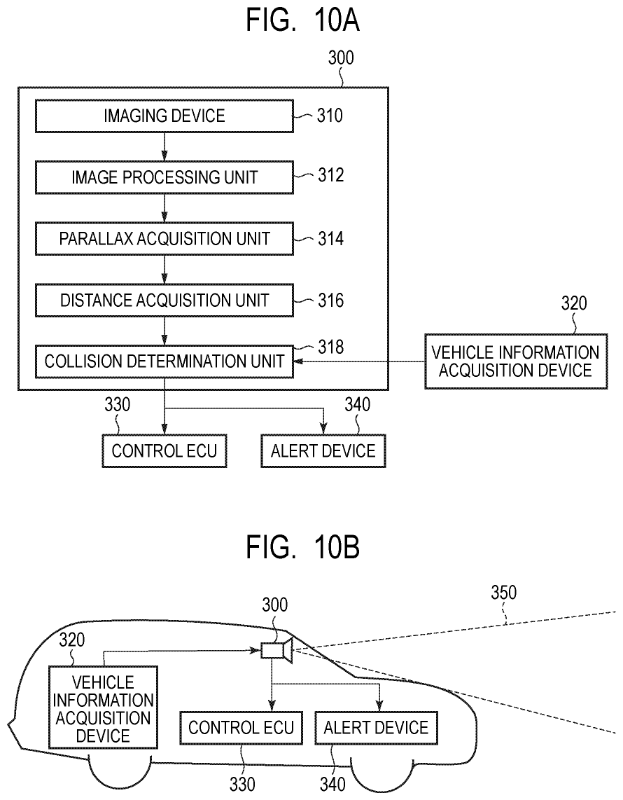

A photoelectric conversion system and a movable object according to a fifth embodiment will be described with reference to FIG. 10A and FIG. 10B. FIG. 10A is a diagram illustrating a configuration of a photoelectric conversion system according to the present embodiment. FIG. 10B is a diagram illustrating a configuration of a movable object according to the present embodiment.

FIG. 10A illustrates an example of a photoelectric conversion system related to an in-vehicle camera. The photoelectric conversion system 300 includes an imaging device 310. The imaging device 310 is the photoelectric conversion device 100 according to any one of the first to third embodiments. The photoelectric conversion system 300 includes an image processing unit 312 that performs image processing on a plurality of image data acquired by the imaging device 310, and a parallax acquisition unit 314 that calculates parallax (phase difference of parallax images) from the plurality of image data acquired by the imaging device 310. The photoelectric conversion system 300 further includes a distance acquisition unit 316 that calculates a distance to an object based on the calculated parallax, and a collision determination unit 318 that determines whether there is a collision possibility based on the calculated distance. Here, the parallax acquisition unit 314 and the distance acquisition unit 316 are examples of a distance information acquisition unit that acquires distance information to the object. That is, the distance information is information related to a parallax, a defocus amount, a distance to the object, and the like. The collision determination unit 318 may determine the collision possibility using any of the distance information. The distance information acquisition unit may be realized by dedicatedly designed hardware or may be realized by a software module. Further, it may be realized by a field programmable gate array (FPGA), an application specific integrated circuit (ASIC), or the like, or may be realized by a combination of these.

The photoelectric conversion system 300 is connected to a vehicle information acquisition device 320, and may acquire vehicle information such as a vehicle speed, a yaw rate, and a steering angle. Further, the photoelectric conversion system 300 is connected to a control ECU 330 which is a control device that outputs a control signal for generating a braking force to the vehicle based on the determination result of the collision determination unit 318. The photoelectric conversion system 300 is also connected to an alert device 340 that issues an alert to the driver based on the determination result of the collision determination unit 318. For example, when the determination result of the collision determination unit 318 indicates that the possibility of collision is high, the control ECU 330 performs vehicle control to avoid collision and reduce damage by, for example, applying a brake, returning an accelerator, or suppressing engine output. The alert device 340 gives an alert to the user by sounding an alarm such as a sound, displaying alert information on a screen of a car navigation system or the like, giving vibration to a seat belt or a steering wheel, or the like.

In the present embodiment, an image of the surroundings of the vehicle, for example, the front or the rear is captured by the photoelectric conversion system 300. FIG. 10B illustrates the photoelectric conversion system in the case of capturing an image in front of the vehicle (imaging range 350). The vehicle information acquisition device 320 sends instructions to the photoelectric conversion system 300 or the imaging device 310. With such configuration, the accuracy of distance measurement may be further improved.

Although an example in which control is performed so as not to collide with another vehicle has been described above, the present embodiment is also applicable to control in which automatic driving is performed so as to follow another vehicle, control in which automatic driving is performed so as not to protrude from a lane, and the like. Further, the photoelectric conversion system is not limited to a vehicle such as an own vehicle, and may be applied to, for example, other movable objects (mobile devices), such as, for example, a ship, an aircraft, or an industrial robot. In addition, the present embodiment is not limited to the movable object and may be widely applied to equipment using object recognition, such as intelligent transport systems (ITS).

### Sixth Embodiment

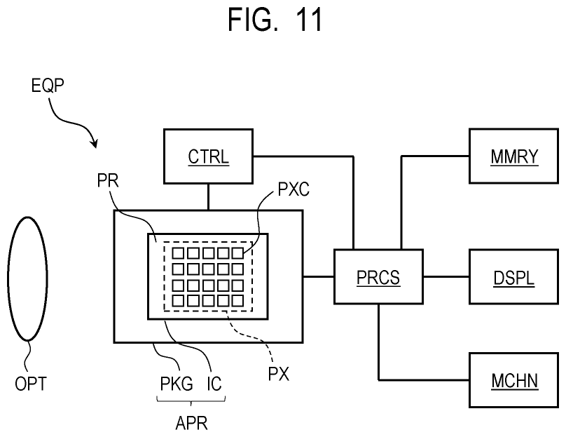

An equipment according to a sixth embodiment will be described with reference to FIG. 11. FIG. 11 is a block diagram illustrating a schematic configuration of an equipment according to the present embodiment.

FIG. 11 is a schematic diagram illustrating an equipment EQP including a photoelectric conversion device APR. The photoelectric conversion device APR has the function of the photoelectric conversion device 100 according to any of the first to third embodiments. All or part of the photoelectric conversion device APR is a semiconductor device IC. The photoelectric conversion device APR of the present example may be used as, for example, an image sensor, an auto focus (AF) sensor, a photometric sensor, or a distance measurement sensor. The semiconductor device IC includes a pixel region PX in which pixel circuits PXC each including a photoelectric conversion unit are arranged in a matrix. The semiconductor device IC may include a peripheral region PR around the pixel region PX. A circuit other than the pixel circuit may be arranged in the peripheral region PR.

The photoelectric conversion device APR may have a structure (chip stacked structure) in which a first semiconductor chip provided with a plurality of photoelectric conversion units and a second semiconductor chip provided with peripheral circuits are stacked. Each of the peripheral circuits on the second semiconductor chip may be column circuits corresponding to pixel columns of the first semiconductor chip. The peripheral circuits on the second semiconductor chip may be matrix circuits corresponding to pixels or pixel blocks on the first semiconductor chip. As the connection between the first semiconductor chip and the second semiconductor chip, a through electrode (through silicon via (TSV)), an inter-chip interconnection by direct bonding of a conductor such as copper, a connection by a micro bump between the chips, a connection by wire bonding, or the like may be employed.

The photoelectric conversion device APR may include a package PKG that accommodates the semiconductor device IC in addition to the semiconductor device IC. The package PKG may include a base body to which the semiconductor device IC is fixed, a lid body such as glass facing the semiconductor device IC, and connection members such as bonding wires or bumps for connecting terminals provided on the base body and terminals provided on the semiconductor device IC.

The equipment EQP may further include at least one of an optical device OPT, a control device CTRL, a processing device PRCS, a display device DSPL, a storage device MMRY, and a mechanical device MCHN. The optical device OPT corresponds to the photoelectric conversion device APR, and is, for example, a lens, a shutter, or a mirror. The control device CTRL controls the photoelectric conversion device APR, and is, for example, a semiconductor device such as an ASIC. The processing device PRCS processes a signal output from the photoelectric conversion device APR and constitutes an analog front end (AFE) or a digital front end (DFE). The processing unit PRCS is a semiconductor device such as a central processing unit (CPU) or an ASIC. The display device DSPL may be an electroluminescent (EL) display device or a liquid crystal display device that displays information (image) obtained by the photoelectric conversion device APR. The storage device MMRY may be a magnetic device or a semiconductor device that stores information (image) obtained by the photoelectric conversion device APR. The storage device MMRY may be a volatile memory such as an SRAM or a DRAM, or a nonvolatile memory such as a flash memory or a hard disk drive. The mechanical device MCHN may include a movable portion or a propulsion portion such as a motor or an engine. In the equipment EQP, a signal output from the photoelectric conversion device APR is displayed on the display device DSPL or transmitted to the outside by a communication device (not illustrated) included in the equipment EQP. Therefore, it is preferable that the equipment EQP further includes a storage device MMRY and a processing device PRCS separately from the storage circuit unit and the arithmetic circuit unit included in the photoelectric conversion device APR.

The equipment EQP illustrated in FIG. 11 may be an electronic device such as an information terminal (for example, a smartphone or a wearable terminal) having a photographing function or a camera (for example, an interchangeable lens camera, a compact camera, a video camera, and a monitoring camera). The mechanical device MCHN in the camera may drive components of the optical device OPT for zooming, focusing, and shutter operation. The equipment EQP may be a transportation device (movable object) such as a vehicle, a ship, or an airplane. The equipment EQP may be a medical device such as an endoscope or a CT scanner.

The mechanical device MCHN in the transportation device may be used as a mobile device. The equipment EQP as a transportation device is suitable for transporting the photoelectric conversion device APR, or for assisting and/or automating operation (manipulation) by an imaging function. The processing device PRCS for assisting and/or automating driving (manipulation) may perform processing for operating the mechanical device MCHN as a mobile device based on information obtained by the photoelectric conversion device APR.

The photoelectric conversion device APR according to the present embodiment may provide a high value to a designer, a manufacturer, a seller, a purchaser, and/or a user thereof. Therefore, when the photoelectric conversion device APR is mounted on the equipment EQP, the value of the equipment EQP may also be increased. Therefore, in manufacturing and selling the equipment EQP, it is advantageous to determine the mounting of the photoelectric conversion device APR of the present embodiment on the equipment EQP in order to increase the value of the equipment EQP.

### Modified Embodiments

The present disclosure is not limited to the above-described embodiments, and various modifications are possible.

For example, an example in which a part of the configuration of any of the embodiments is added to another embodiment or an example in which a part of the configurations of any of the embodiments is substituted with some of the configurations of another embodiment is also an embodiment of the present disclosure.

Further, in the above-described embodiments, an example in which the optical flow is calculated for each pixel block of (4 columns)×(4 rows) has been described, but the pixel block as a unit for calculating the optical flow is not limited to (4 columns)×(4 rows), and may be set to an arbitrary size. Further, in the above-described embodiments, an example in which the gradient is calculated for each pixel block of (2 columns)×(2 rows) has been described, but the pixel block as a unit for calculating the gradient is not limited to (2 columns)×(2 rows), and may be set to an arbitrary size. A Sobel filter, a Prewitt filter, or the like may be used to calculate the gradient. In a case where the photoelectric conversion device includes a color filter, a gradient may be independently obtained for each channel. That is, the gradient of R, the gradient of G, and the gradient of B may be obtained.

In the above-described embodiments, data is read out by transferring data in the column direction (vertical direction), but data may be read out by transferring data in the row direction (horizontal direction). In addition, the transfer in the column direction and the transfer in the row direction may be selectively used in the readout of the count value and the readout of the vector value.

The photoelectric conversion systems described in the fourth and fifth embodiments are examples of photoelectric conversion systems to which the photoelectric conversion device of the present disclosure may be applied, and the photoelectric conversion system to which the photoelectric conversion device of the present disclosure may be applied is not limited to the configuration illustrated in FIG. 9 and FIG. 10A.

According to the present disclosure, it is possible to realize a photoelectric conversion device capable of acquiring an optical flow at high speed without requiring data processing by an external device.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

The present disclosure is not limited to the above-described embodiments, and various changes and modifications may be made without departing from the spirit and scope of the present disclosure. Accordingly, the following claims are attached to clarify the scope of the present disclosure.

1. A photoelectric conversion device comprising:
a plurality of photoelectric conversion units each configured to output a photon detection signal according to incidence of a photon;
a plurality of counters each configured to count the photon detection signal of a corresponding photoelectric conversion unit; and
a calculation unit configured to perform arithmetic processing based on count values of the plurality of counters,
wherein the calculation unit includes:
a holding unit configured to hold count values of the plurality of counters; and
a vector calculation unit configured to calculate a vector value representing an optical flow between a first time and a second time earlier than the first time based on a count value of the counter at the first time and a count value of the counter at the second time, count value being held by the holding unit.

2. The photoelectric conversion device according to claim 1, further comprising: an output selection unit configured to select and output at least one of the count value of the counter and the vector value.

3. The photoelectric conversion device according to claim 2, further comprising: a plurality of pixels each including the photoelectric conversion unit and the counter,
wherein the plurality of pixels is divided into a plurality of pixel blocks each including two or more pixels,
wherein the calculation unit is provided for each of the pixel blocks,
wherein each of the calculation units is configured to calculate the vector value based on the count value at the first time of the pixel included in a corresponding pixel block and the count value at the second time of the pixel included in the corresponding pixel block.

4. The photoelectric conversion device according to claim 3, further comprising: a signal processing unit configured to perform a signal processing on the count value or the vector value output from the output selection unit,
wherein the plurality of pixel blocks is arranged to form a plurality of columns,
wherein adjacent output selection units arranged in a same pixel block column are connected to each other, and
wherein the count value or the vector value output from one output selection unit is transferred to the signal processing unit via another output selection unit arranged in a same pixel block column.

5. The photoelectric conversion device according to claim 3, further comprising: a signal processing unit configured to perform a signal processing on the count value or the vector value output from the output selection unit,
wherein the plurality of pixel blocks is arranged to form a plurality of rows,
wherein adjacent output selection units arranged in a same pixel block row are connected to each other, and
wherein the count value or the vector value output from one output selection unit is transferred to the signal processing unit via another output selection unit arranged in a same pixel block row.

6. The photoelectric conversion device according to claim 3,
wherein the calculation unit further includes a motion determination unit configured to determine a motion of an object based on the vector value, and
wherein the output selection unit outputs a signal indicating that the object is not moving when the motion determination unit determines that the object is not moving instead of outputting the vector value.

7. The photoelectric conversion device according to claim 3, wherein the pixel is configured to be capable of reading out a count value of the counter always by the calculation unit.

8. The photoelectric conversion device according to claim 1,
wherein the calculation unit further includes a gradient calculation unit configured to calculate a gradient representing a spatial and temporal luminance gradient based on the count value at the second time and the count value at the first time, and
wherein the vector calculation unit calculates the vector value based on the gradient calculated by the gradient calculation unit.

9. The photoelectric conversion device according to claim 1, wherein the calculation unit further includes a filtering unit configured to perform a filtering process using a similarity in a time direction on the vector value.

10. The photoelectric conversion device according to claim 1, wherein the first time and the second time are included in one exposure period.

11. The photoelectric conversion device according to claim 10, wherein the counter is configured to continuously perform a count operation during the exposure period.

12. The photoelectric conversion device according to claim 2,
wherein the first time and the second time are included in one exposure period, and
wherein the output selection unit is configured to output a count value of the counter at a time when the exposure period elapses.

13. The photoelectric conversion device according to claim 10, wherein the calculation unit is configured to calculate the vector value a plurality of times during the one exposure period.

14. The photoelectric conversion device according to claim 1, wherein the photoelectric conversion unit includes an avalanche photodiode and is configured to output a pulse signal that is the photon detection signal in response to incidence of a photon.

15. The photoelectric conversion device according to claim 1 further comprising:
a first substrate provided with the plurality of photoelectric conversion units; and
a second substrate stacked on the first substrate and provided with the calculation unit.

16. A photoelectric conversion device comprising:
a plurality of photoelectric conversion units each configured to output a photon detection signal according to incidence of a photon;
a plurality of counters each configured to count the photon detection signal of a corresponding photoelectric conversion unit; and
a calculation unit configured to perform arithmetic processing based on count values of the plurality of counters,
wherein the calculation unit is configured to periodically acquire the count values from the plurality of counters while the counters perform a series of count operations, output a vector value representing an optical flow based on the acquired count values at a first cycle, and output the count values of the plurality of counters at a second cycle longer than the first cycle.

17. The photoelectric conversion device according to claim 16, wherein the second cycle corresponds to an exposure period of the photoelectric conversion unit.

18. The photoelectric conversion device according to claim 16, wherein each of the plurality of photoelectric conversion units includes an avalanche photodiode.

19. A photoelectric conversion device comprising:
a plurality of pixels each including a photoelectric conversion unit configured to output a photon detection signal according to incidence of a photon and a counter configured to count the photon detection signal of the photoelectric conversion unit; and
a calculation unit configured to calculate a vector value representing an optical flow between a first time and a second time different from the first time based on count values of the counters of the plurality of pixels at the first time and count values of the counters of the plurality of pixels at the second time,
wherein the plurality of pixels is divided into a plurality of pixel blocks each including two or more pixels and arranged to form a plurality of rows and a plurality of columns,
wherein the calculation unit is provided for each of the plurality of pixel blocks, and
wherein adjacent calculation units arranged in a same pixel block row or a same pixel block column are connected to each other, and the vector value output from one calculation unit is transferred through another calculation unit arranged in the same pixel block row or the same pixel block column.

20. An equipment comprising:
the photoelectric conversion device according to claim 1; and
at least one of
an optical device corresponding to the photoelectric conversion device,
a control device configured to control the photoelectric conversion device,
a processing device configured to process a signal output from the photoelectric conversion device,
a mechanical device that is controlled based on information obtained by the photoelectric conversion device,
a display device configured to display information obtained by the photoelectric conversion device, and
a storage device configured to store information obtained by the photoelectric conversion device.
